(19) United States
(12) Patent Application Publication
(10) Pub. No.: US 2024/0028983 A1
(43) Pub. Date: Jan. 25, 2024

(54) METHOD OF PRODUCTION SCHEDULING FOR PRODUCT, ELECTRONIC DEVICE AND STORAGE MEDIUM

(71) Applicants: Beijing Zhongxiangying Technology Co., Ltd., Beijing (CN); BOE Technology Group Co., Ltd., Beijing (CN)

(72) Inventors: Xieming Su, Beijing (CN); Xuemei Lin, Beijing (CN); Yang Li, Beijing (CN); Xixun Liu, Beijing (CN); Nan Liu, Beijing (CN); Chuan Wang, Beijing (CN); Zhai Lu, Beijing (CN); Guihao Liu, Beijing (CN); Hua Zhang, Beijing (CN); Hong Wang, Beijing (CN); Jianmin Wu, Beijing (CN)

(21) Appl. No.: 18/246,891

(22) PCT Filed: Feb. 22, 2022
(86) PCT No.: PCT/CN2022/077231

§ 371 Date: Mar. 28, 2023

(51) Int. Cl. G06Q 10/0631

(52) U.S. Cl. CPC G06Q 10/0631

(57) ABSTRACT

Provided are a method of production scheduling for a product, including: acquiring basic data for performing a production scheduling for the product; determining at least one production process from a plurality of production processes of the product as a bottleneck process according to the basic data; performing the production scheduling for the product using a linear programming solution model to obtain a first scheduling result of the product; merging a plurality of first entries corresponding to same products having production dates falling within a same time range into a second entry to obtain a plurality of second entries, wherein each of the second entries includes a production quantity of a same product in a time range; and acquiring orders corresponding to each product and sorting the orders of the product according to at least one of an order delivery date and an order priority to obtain an order sorting result.

### CROSS-REFERENCE TO RELATED APPLICATION

This application is a Section 371 National Stage Application of International Application No. PCT/CN2022/077231, filed on Feb. 22, 2022, entitled “METHOD OF PRODUCTION SCHEDULING FOR PRODUCT, ELECTRONIC DEVICE AND STORAGE MEDIUM”, the content of which is hereby incorporated by reference in its entirety.

### TECHNICAL FIELD

The disclosure relates to a field of production scheduling technology, and in particular, to a method of production scheduling for a product, an electronic device, a storage medium and a computer program product.

### BACKGROUND

A panel manufacturing process usually needs to go through a manufacturing of an array substrate (Array), a manufacturing of a display cell (Cell), and a manufacturing of a display module (Module). The production cycle is not only long, but also the sequential correlation sequence among various manufacturing processes is strong. Once the production rhythms of the preceding and subsequent manufacturing processes do not match, it will not only lead to a decrease in the utilization rate of the plant capacity, but it may also cause a bottleneck drift of the manufacturing process due to the diversity of panel manufacturing processes, product models, materials, and production start sequences. This may further result in an accumulation of Working-in-progress (WIP).

### SUMMARY

According to the present disclosure, there is provided a method of production scheduling for a product, an electronic device, a storage medium and a computer program product. According to an aspect of the present disclosure, there is provided a method of production scheduling for a product, including:
acquiring basic data for performing a production scheduling for the product;
determining at least one production process from a plurality of production processes of the product as a bottleneck process according to the basic data;
performing the production scheduling for the product using a linear programming solution model to obtain a first scheduling result of the product, wherein the linear programming solution model includes a constraint condition and an objective function for the bottleneck process, the first scheduling result includes a plurality of first entries, and each of the first entries includes a production date, a production quantity and corresponding production resources of the product;
merging a plurality of first entries corresponding to same products having production dates falling within a same time range into a second entry to obtain a plurality of second entries, wherein each of the second entries includes a production quantity of a same product in a time range; and
for the product in each of the second entries, acquiring orders corresponding to the product and sorting the orders of the product according to at least one of an order delivery date and an order priority to obtain an order sorting result.

According to an embodiment of the present disclosure, the method further includes:
constructing a production data model of the product, wherein the production data model includes a correlation between a semi-finished product and production resources, materials and processes used to produce the semi-finished product, a correlation between a finished product and production resources, materials and processes used to produce the finished product, and a correlation between the finished product and the semi-finished product;
extracting a production demand of each of the processes from each of the orders, wherein the production demand of each of the processes includes a quantity of a finished product or a semi-finished product planned to be produced through this process; and
allocating a production demand of each of the orders to a corresponding production resource and a corresponding production period based on the production data model and the order sorting result to obtain a second scheduling result, wherein the second scheduling result includes a production demand corresponding to each production resource in each production period.

According to an embodiment of the present disclosure, wherein the allocating a production demand of each of the orders to a corresponding production resource and a corresponding production period based on the production data model and the order sorting result includes:
determining a sequence of various processes of the product and a production resource involved in each of the processes based on the production data model; and
performing an allocation of a production demand on each of the orders according to an order sequence in the order sorting result, wherein the allocation of a production demand includes allocating a production demand of each of the processes extracted from the order to a corresponding production resource and a corresponding production period, wherein a production period corresponding to a production demand of a process sorted ahead is after a production period corresponding to a production demand of a process sorted behind.

According to an embodiment of the present disclosure, wherein the allocating a production demand of each of the processes extracted from the order to a corresponding production resource and a corresponding production period includes:
allocating a production demand of each of the processes extracted from the order to a corresponding production resource and a corresponding production period by a forward scheduling method or a backward scheduling method.

According to an embodiment of the present disclosure, wherein the constraint condition includes at least one of: a first constraint condition for a device capacity, a second constraint condition for a production line priority, a third constraint condition for a plant running time, a fourth constraint condition for a material, and a fifth constraint condition for a line changing frequency.

According to an embodiment of the present disclosure, the first constraint condition indicates a sum of a planned production volume of each device for the day*takt time<device available time*device utilization rate; the second constraint condition indicates that a priority of an internal plant is a first priority, a priority of an external foundry is a second priority, and the first priority is inferior than the second priority; the third constraint condition indicates that a plant transit time is within a preset range; the fourth constraint condition indicates that quantities of semi-finished products and materials used to produce a display module are within a preset range; and the fifth constraint condition indicates that a quantity of models of the display module produced by each device per day is less than a preset value.

According to an embodiment of the present disclosure, wherein the objective function includes at least one of: a first objective function configured to maximize a demand satisfaction degree for a product, a second objective function configured to minimize a quantity of a product with a delayed delivery date, a third objective function configured to maximize a utilization rate of a device for producing a product, a fourth objective function configured to minimize a plant running time, and a fifth objective function configured to maximize a time of a continuous production for a product on a same production line.

According to an embodiment of the present disclosure, the first objective function is Max(demand satisfaction degree), wherein the demand satisfaction degree=an accumulated quantity of display modules to be delivered in multiple orders/a total demand quantity of display modules; the second objective function is Min(delayed delivery quantity), wherein the delayed delivery quantity=an accumulated quantity of display modules to be delivered out of a delivery date in multiple orders/a total demand quantity of display modules; the third objective function is Max(device capacity utilization rate), wherein the device capacity utilization rate=an accumulated device usage time in one day/an accumulated (a device availability time*a device utilization rate) in one day; the fourth objective function is Min(inter-plant transit time), where the plant running time is an accumulated inter-plant transportation time in multiple orders; the fifth objective function is Max(time of a continuous production for a display module of each model on a same production line); wherein Max( ) represents to maximize a calculation, and Min( ) represents to minimize a calculation.

According to an embodiment of the present disclosure, the method further includes: removing a stock quantity from each of the orders in the order sorting result, after obtaining the order sorting result.

According to an embodiment of the present disclosure, wherein the production date is in a unit of day or week, and the time range is in a unit of month or quarter.

According to an embodiment of the present disclosure, wherein the product is a display module, the semi-finished product includes an array substrate and a display unit including an array substrate, and the finished product is a display model including a display unit.

According to an embodiment of the present disclosure, wherein the determining at least one production process from a plurality of production processes of the product as a bottleneck process includes:

selecting at least one process from a plurality of processes involved in a post core process of the product as the bottleneck process of the product based on a production demand of a plant used to produce the product.

According to another aspect of the present application, there is provided an electronic device, including a memory and a processor, wherein the memory stores instructions executable by the processor therein, and the instructions, when executed by the processor, cause the processor to perform the method as described above.

According to another aspect of the present application, there is provided a non-transitory computer-readable storage medium storing computer instructions, wherein the computer instructions are configured to cause the computer to perform the method as described above.

According to another aspect of the present application, there is provided a computer program product, including a computer program, wherein the computer program, when executed by a processor, implements the method as described above.

### BRIEF DESCRIPTION OF THE DRAWINGS

The accompanying drawings are used to better understand the present solution, and do not constitute a limitation to the present disclosure, in which:

FIG. 1 is a flow chart of a method of production scheduling for a product according to an embodiment of the present disclosure;

FIG. 2 is a schematic diagram of a method for acquiring basic data according to an embodiment of the present disclosure;

FIG. 3 is a schematic diagram of a method for determining a bottleneck process according to an embodiment of the present disclosure;

FIG. 4 is a flowchart of a method of production scheduling for a product according to another embodiment of the present disclosure;

FIG. 5 is a flowchart of a method for obtaining a second scheduling result based on a production data model and an order sorting result according to an embodiment of the present disclosure;

FIG. 6 is a schematic diagram of obtaining a second scheduling result based on a production data model and an order sorting result according to an embodiment of the present disclosure; and

FIG. 7 is a block diagram of an electronic device for implementing a method of production scheduling for a product according to an embodiment of the present disclosure.

### DETAILED DESCRIPTION OF EMBODIMENTS

Exemplary embodiments of the present disclosure are described below in combination with the accompanying drawings, which include various details of the embodiments of the present disclosure to facilitate understanding, and they should be regarded as exemplary only. Accordingly, those of ordinary skill in the art will recognize that various changes and modifications of the embodiments described herein may be made without departing from the scope and spirit of the present disclosure. Also, descriptions of well-known functions and structures are omitted in the following description for clarity and conciseness.

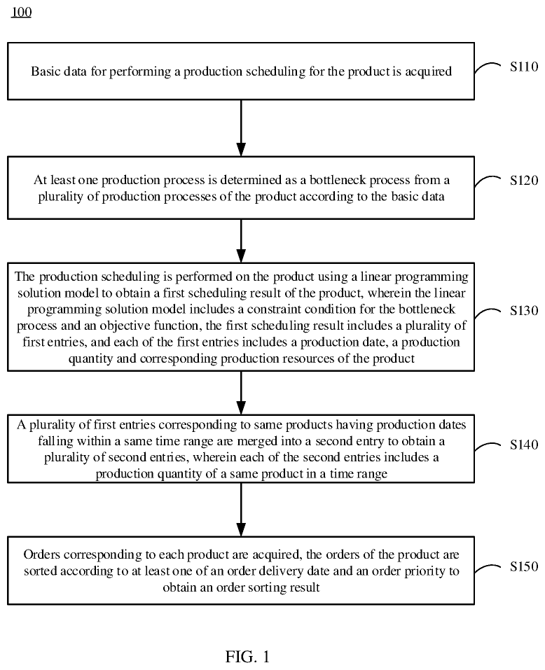

FIG. 1 is a flow chart of a method of production scheduling for a product according to an embodiment of the present disclosure.

As shown in FIG. 1, the method 100 of production scheduling for a product includes operations S110-S150. The method in the embodiments of the present disclosure may be a computer-implemented method. For example, the method of production scheduling in the embodiments of the present disclosure may be implemented by a computer based on an Advanced Planning and Scheduling (APS) system. The APS system is a system that comprehensively considers constraint conditions of resources, such as material, device, personnel, production capacity, customer requirement, and transportation, and uses an optimization algorithm to automatically generate a plant production plans and a production scheduling.

In operation S110, basic data for performing a production scheduling for the product is acquired.

The basic data here may include sales demand data and production information data. The sales demand data may include, for example, product-related sales demand information (such as order delivery date as well as sales and inventory plan). The production information data may include, for example, material demand and supply situation, production process information, production cycle, semi-finished product inventory information, process yield rate, and the like. In the embodiments of the present disclosure, a production scheduling may be performed on a product according to the acquired basic data.

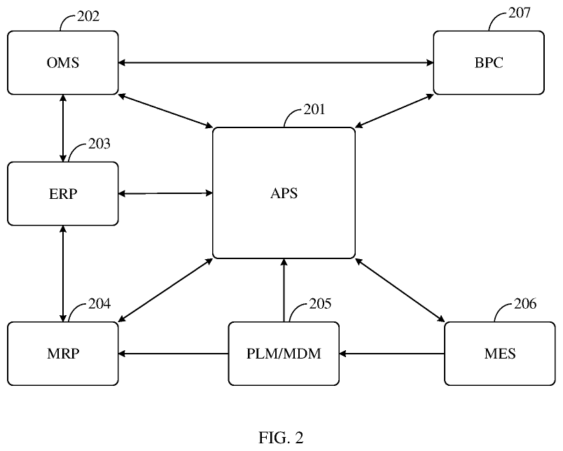

As shown in FIG. 2, for example, an APS system 201 may be used to respectively acquire sales demand information (such as order delivery date as well as sales and inventory plan) from an Order Management System (OMS) 202, acquire data related to product or semi-finished product inventory information from An Enterprise Resource Planning (ERP) 203, acquire data related to material demand and supply planning from a Material Requirement Planning (MRP) system 204, acquire data related to production process from a PLM (Product Lifecycle Management)/MDS (Master Data Management) integrated system 205, acquire data related to production performance or on-the-job status (such as process yield rate) from a Manufacturing Execution System (MES) 206, or acquired data related to revenue, profit or cost plan from a Business Planning and Consolidation (BPC) system 207. Data interaction among the above systems may be achieved. For example, for the MRP system 204, in addition to providing data related to material demand and supply planning to the APS system 201, the MPS system 204 may, for example, acquire a corresponding production plan from the APS system 201, acquire Bill of Material (BOM) information from the PLM/MDM integrated system 205, acquire data related to material inventory from the ERP system 203, and provide material purchasing information (such as purchase requisition PR) to the ERP system 203. On the basis that the function of data interaction among the above systems may be achieved, the APS system 201 may regularly (or irregularly) acquire basic data for performing a production scheduling for a product. It should be noted that what is shown in FIG. 2 is only an example of acquiring basic data, and is not intended to limit the scope of the present disclosure.

The product described above may be, for example, any one or more finished products processed through a plurality of production processes, which may be determined according to actual situations.

In the embodiments of the present disclosure, the product described may be, for example, a display panel or a display module in a display panel, and a display module is mainly taken as an example in the following description. A display module is mainly obtained through processing of an array substrate (Array) process, a display cell (Cell) process and a display module (Module) process. It may be understood that the solution of the present disclosure may be applied to the production scheduling of any of the above products, the description of the display module as an example in the specification and the drawings is only illustrative to help those skilled in the art understand the solution of the present disclosure, and the present disclosure is not limited thereto.

In operation S110, for example, basic data for performing a production scheduling for a display module may be acquired according to the method described above, and the production scheduling of the display module may be subsequently performed according to the acquired basic data, which will not be repeated here.

Referring back to FIG. 1, in operation S120, at least one production process is determined as a bottleneck process from a plurality of production processes of a product according to the basic data.

As the entire manufacturing process of a product includes a plurality of production processes, and the sequential correlation sequence among various production processes is strong. In the actual production scheduling process, the production plan of a subsequent production process usually needs to consider the supply of a previous production process, and each of the production processes may also involve a variety of product models, materials, manufacturing processes, etc. Once a problem occurs in one of the steps or processes, it may eventually affect the achievement of the production plan of the product. Based on the above considerations, before formulating the production plan of the product, at least one production process may be determined as a bottleneck process from a plurality of production processes of the product. A Bottleneck Process usually refers to one or more production processes or technological processes that constrain the output of the entire production line. A bottleneck process is mainly defined for the production flow, and the resources of the bottleneck process determine the output volume and inventory level. Usually, a step with the slowest production takt (Take Time, TT) in one flow is called “bottleneck”. As the production takts of a plurality of production processes of a product may be different, it will affect the production takt of each production process. Based on practical considerations, at least one process may be determined as the bottleneck process from a plurality of processes of the product based on the basic data, so that the bottleneck process may be predicted in advance, and the bottleneck process may be improved in the future to avoid the accumulation of materials and work in progress, thereby increasing the production capacity utilization rate of the process.

In the embodiments of the present disclosure, the bottleneck process, for example, may be determined according to the production capacity of each process, for example, a process with the smallest production capacity is selected as the bottleneck process. The production capacity of each process may be obtained according to the basic data acquired in operation S110.

Taking the product being a display module as an example, as described above, the production process of the display module mainly includes a process section of manufacturing an array substrate (Array), a process section of manufacturing a display cell (Cell), and a process of manufacturing a display module (Module). In the actual production scheduling process, the production plan for the process section of the display module usually needs to consider the supply of the process section of the display cell, and the production plan for the process section of the display cell usually needs to consider the supply of the process section of the array substrate.

After acquiring the basic data related to the display module according to the above steps, the sales demand information related to the display module (such as the sales demand of various models of products), the process yield rate of each process, the take time of each process, the production line or device resources, etc. may be extracted from the basic data. The production demand of the plant for producing the array substrate, the production demand of the plant for producing the display cell, and the production demand of the plant for producing the display module may be determined according to the product sales volume and the process yield rate of each process. Then, the bottleneck process of the array substrate is determined based on the production demand of the plant for producing the array substrate according to the production capacity of each process of producing the array substrate. The bottleneck process of the display cell is determined based on the production demand of the plant for producing the display cell according to the production capacity of each process of producing the display cell. The bottleneck process of the display module is determined based on the production demand of the plant for producing the display module according to the production capacity of each process of producing the display module.

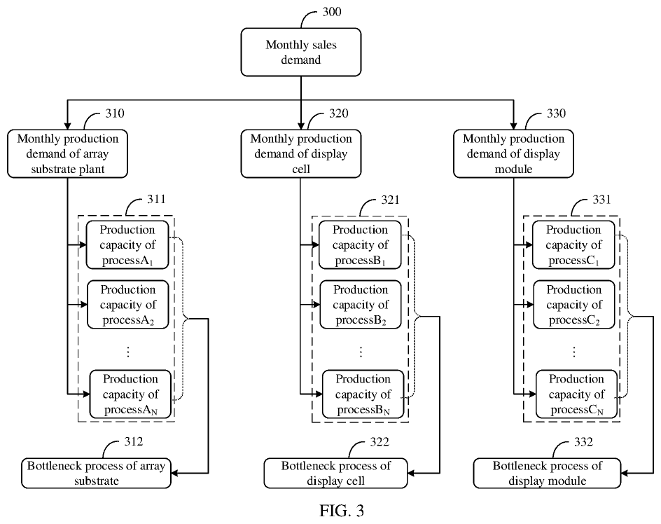

FIG. 3 is a schematic diagram of a method for determining a bottleneck process according to an embodiment of the present disclosure. An exemplary implementation of the method for determining a bottleneck process will be described below with reference to FIG. 3. It should be noted that the process of determining the bottleneck process of each production process is the same or similar, and the determination of the bottleneck process of the display module will be used as an example for introduction. In addition, as each process may also involve multiple product models, materials, manufacturing processes, etc., in order to save space, unless otherwise specified, the following process-related data (such as production capacity, production demand) may refer to, for example, the situation including various product models, which will not be described in detail below.

As shown in FIG. 3, after the basic data is acquired, the monthly sales demand of various models of display modules, the take time of each process, the production line or device resource situation, the inventory data, the process yield rate of each process, etc. may be extracted from the basic data. In the case of considering inventory, the monthly production demand of a corresponding process (including various models) is calculated according to the monthly sales demand of various models of display modules and the process yield rate of each process, wherein the monthly production demand of each process=Σ(monthly sales demand of various models of products/process yield rate of a corresponding process). For example, the monthly production demand 330 of each model of display module may be calculated according to the monthly sales demand 300 of various models of display modules and the process yield rate of the process of the display module.

For example, the process section of manufacturing an array substrate (Array) includes, for example, process A₁, process A₂, . . . , process A_{N}, and the process section of manufacturing a display cell (Cell) includes, for example, process B₁, process B₂, . . . , process B_{N}, and the process section of manufacturing a display module (module) includes, for example, process C₁, process C₂, . . . , process C_{N}, and each process corresponds to its own take time.

Taking the process C₁, process C₂, . . . , process C_{N} involved in the manufacture of a display module (module) as an example, for each process, according to the take time (TT) corresponding to each process, the production capacity 331 (including various models) of each process may be obtained by calculation using the production line resource situation (such as the available quantity of device, the device availability time, and the overall efficiency of device) and the monthly production demand 330 of each model of display module. In some embodiments, when the production capacity 331 of the process is calculated, the processing layer number of the finished product or semi-finished product corresponding to the process may also be considered. For example, in the case that the product is a display module, the array substrate may include multiple layers. The layer number of the array substrate is considered when the production capability of the process of the array substrate is calculated. For the processes of display cell and the display module, it may be considered that the processing layer number is one. The production capacity 331 of each process=availability time of device*quantity of device*overall device efficiency (OEE)/(Σ(monthly production demand of various models of products*TT)/total monthly production demand). For example, for process C₁, assuming that the take time corresponding to process C₁ is TT₁, the quantity of available device is n1, the available time of each device is t1, and the overall efficiency of each device is al, the production capacity of process C₁ may be obtained by calculation according to the above data. Likewise, the production capacities of other processes, such as the production capacities of process C₂ to process C_{N}, may be obtained using the above method. After the production capacity 331 of each process is obtained, the bottleneck process 332 is determined by comparing the production capacity of each process, for example, the process with the smallest production capacity may be selected as the bottleneck process. For example, for process C₁ to process C_{N}, the production capacities corresponding to various processes are respectively m₁<m₂< . . . <m_{N}, then the process C₁ is determined to be the bottleneck process 332 of the display module. In a similar manner, the bottleneck process of the array substrate and the bottleneck process of the display cell may also be calculated, which will not be repeated here.

In some embodiments, when the bottleneck process of each process is determined, the processing time (such as the layer number (layer)) may also be considered. For example, for process C₁, assuming that the number of layers that needs to be processed by process C₁ is d₁, then the production capacity of process C₁=(available time of device*quantity of device*overall device efficiency (OEE))/weighted processing times/(Σ(monthly production demand of various models of products*TT)/total monthly production demand). The production capacities of other processes may be determined using the above method, so as to determine the bottleneck process of the process of the display module process.

Based on the method described above, according to the basic data, at least one production process may be determined as the bottleneck process from a plurality of production processes of the display module, and these bottleneck processes will be used as objects of production scheduling for performing a production scheduling on the display module. For example, at least one bottleneck process 312 of the array substrate, at least one bottleneck process 322 of the display cell, and at least one bottleneck process 332 of the display module are respectively determined from the process of the array substrate, the process of the display cell, and the process of the display module of the display module.

In some embodiments, the determining at least one production process from a plurality of production processes of the product as a bottleneck process includes: determining the bottleneck process of the product according to the production capacity of a post core process of the product based on a production demand of a plant used to produce the product.

For at least one bottleneck process determined from a plurality of production processes of the product, as each bottleneck process has a different impact on the output volume and inventory level of the product, the bottle process of the core process may be determined from multiple bottleneck processes determined above for use in a subsequent production scheduling for the product. By considering the bottleneck process of the core process for a production scheduling for the product, a more targeted production plan may be obtained, thereby improving the capacity utilization rate of the entire process. As mentioned above, a product may be manufactured sequentially through processes of multiple sections (also referred to as process sections), and each process section includes a plurality of processes. For a product whose production procedure involves multiple stages and spans a long time, controlling the post core process may ensure a final achievement of the order.

For example, as mentioned above, the manufacturing process of a display panel needs to go through multiple process sections of Array, Cell, and Module, and the production procedure spans a long time. Due to such production characteristics of the panel, the production procedure of the display panel is mainly limited by the post core process. The bottleneck process may be determined from a plurality of processes involved in the process section of the display module, and then the production scheduling may be arranged according to the bottleneck process in the process section of the display module. For example, the bottleneck process may be determined from a plurality of processes involved in the process section of the display module according to the above manner. The details will not be repeated here.

Referring back to FIG. 1, in operation S130, for the constraint conditions of the bottleneck process, a linear programming solution is performed on the objective function to obtain a first scheduling result of the product, the first scheduling result includes a plurality of first entries, and each of the first entries includes a production date, a production quantity and corresponding production resources of the product.

After the bottleneck process is determined, a linear programming solution may be performed on the objective function according to the constraint conditions of the bottleneck process, so as to obtain the first scheduling result of the product.

In the embodiments of the present disclosure, for the constraint conditions of the bottleneck process, a linear programming solution is performed on the objective function, for example, an optimizer may be used for implementation. Before the basic data is input into the optimizer, these data may be preprocessed, so that these data is converted into a preset format (such as TXT format) for a subsequent linear programming solution. Table 1 schematically shows some examples of converting the basic data into a preset format.

TABLE 1

| Name | Description |
|---|---|
| IN_CELL | indicating the material master data including an |
| | array substrate product |
| IN_DEMAND | indicating demand data is included, wherein each |
| | demand data is represented by a demand ID, a |
| | product, a due date, a cancellation date, a quantity, |
| | a priority and a customer |
| IN_OPER | indicating an operation in this model, such as assembly |

According to the processing method in Table 1, preprocess the basic data corresponding to each bottleneck process is preprocessed, so that the basic data is converted into a preset format. After the converted data is read by the optimizer, a linear programming solution is performed on the objective function in combination with the constraint conditions of each bottleneck process, so as to obtain the first scheduling result of the product. The first scheduling result includes a plurality of first entries, and each of the first entries includes a production date, a production quantity and corresponding production resources of the product.

In the embodiments of the present disclosure, the bottleneck process involves related devices, production lines, plants, materials, etc. The constraint condition of a bottleneck process may include at least one of: a first constraint condition for a device capacity, a second constraint condition for a production line priority, a third constraint condition for a plant running time, a fourth constraint condition for a material, and a fifth constraint condition for a line changing frequency.

The first constraint condition indicates a sum of a planned production volume of each device for the day*takt time<device availabile time*device utilization rate; the second constraint condition indicates that a priority of an internal plant is a first priority, a priority of an external foundry is a second priority, and the first priority is inferior than the second priority; the third constraint condition indicates that a plant transit time is within a preset range; the fourth constraint condition indicates that quantities of semi-finished products and materials used to produce a display module are within a preset range; and the fifth constraint condition indicates that a quantity of models of the display module produced by each device per day is less than a preset value.

The objective function described above may, for example, include at least one of: a first objective function configured to maximize a demand satisfaction degree for the display module, a second objective function configured to minimize a quantity of the display module with a delayed delivery date, a third objective function configured to maximize a utilization rate of a device for producing the display module, a fourth objective function configured to minimize a plant running time, and a fifth objective function configured to maximize a time of a continuous production for the display module on a same production line.

The first objective function is Max(demand satisfaction degree), wherein the demand satisfaction degree=an accumulated quantity of display modules to be delivered in multiple orders/a total demand quantity of display modules; the second objective function is Min(delayed delivery quantity), wherein the delayed delivery quantity=an accumulated quantity of display modules to be delivered out of a delivery date in multiple orders/a total demand quantity of display modules; the third objective function is Max(device capacity utilization rate), wherein the device capacity utilization rate=an accumulated device usage time in one day/an accumulated (a device availability time*a device utilization rate) in one day; the fourth objective function is Min(inter-plant transit time), where the plant running time is an accumulated inter-plant transportation time in multiple orders; the fifth objective function is Max(time of a continuous production for a display module of each model on a same production line); wherein Max( ) represents to maximize a calculation, and Min( ) represents to minimize a calculation. In some embodiments, weights may be set separately for each objective function as required. For example, the weights of the first objective function to the fifth objective function may be set as 1, 0.1, 0.001, 0.001, and 0.001, respectively.

In the embodiments of the present disclosure, a linear programming solution is performed on the objective function according to the basic data corresponding to each bottleneck process and the constraint conditions of each bottleneck process, so as to obtain the first scheduling result of the display module. This process may be understood as finding an optimal solution that satisfies the constraint parameters of the production scheduling of the product and the objective function, i.e., the first scheduling result of the product, according to the basic data corresponding to the bottleneck process of the product using the optimizer (such as Xpress-Optimizer). The Xpress-Optimizer is a solution engine in an Xpress-MP toolkit. The XPress-MP is a mathematical modeling and optimization toolkit for solving linear, integer, quadratic, and stochastic programming problems. The XPress-MP toolkit may be used on a computer platform, and has versions of different performances to solve problems of various scales. The algorithm contained in the Xpress-Optimizer of the XPress-MP toolkit enables the solution of linear programming problems, mixed integer programming problems, quadratic programming problems, and mixed integer quadratic programming problems.

In the present disclosure, the bottleneck process is predicted in advance, and the basic data of the bottleneck process of the product process is used as an input of the linear programming result, so as to obtain the first scheduling result that satisfies the constraint conditions of the product production scheduling and the objective function. Based on the above method, it is possible to alleviate or even avoid a mismatch of the production rhythm between the preceding and subsequent processes and a drift of the bottleneck process, thereby improving the capacity utilization rate of the production line capacity.

Table 2 schematically shows some first scheduling results for the product. As shown in Table 2, the first scheduling result includes a plurality of first entries, and each of the first entries includes a production date, a production quantity and a corresponding production resource of the product. For example, in the entry with the serial number 1, the production date of product with the model A1 is 2021-9-14, the production quantity is 100, and the production resource is production line 4. In Table 2, the production date is calculated in days, but the embodiments of the present disclosure are not limited thereto, and the production date may be calculated in other calculation units, such as weeks. The first scheduling result of the product obtained based on operation S130 is a production scheduling in an ideal state given comprehensive consideration of factors such as device capacity, production line priority, plant running time, materials, and production line change times. However, the production scheduling result of the product obtained based on the linear programming solution method have certain limitations, and it is difficult to express the production continuity and production sequence. For example, in Table 2, product A1 was put into production at intervals between September 18 and September 21, and such a result deviates from the actual production demand.

TABLE 2

| Serial | Production | Production | Product | Production | Quan- |
|---|---|---|---|---|---|
| number | plant | device | model | time | tity |
| 1 | Plant1 | Production line4 | A1 | 2021 Sep. 14 | 100 |
| 2 | Plant 1 | Production line 4 | A1 | 2021 Sep. 15 | 100 |
| 3 | Plant 1 | Production line 5 | A1 | 2021 Sep. 18 | 100 |
| 4 | Plant 1 | Production line 5 | A1 | 2021 Sep. 21 | 50 |
| 5 | Plant 2 | Production line 1 | A2 | 2021 Sep. 14 | 80 |
| 6 | Plant 2 | Production line 2 | A2 | 2021 Sep. 14 | 50 |

In the embodiments of the present disclosure, the difference between the first scheduling result of the product obtained by the linear programming solution method and the actual scheduling process will be considered. For example, as the production continuity and the production sequence may not be expressed, a product sorting and an order sorting are performed on the first scheduling result of the product, so as to obtain an order sorting result, which will be described in detail below with reference to operation S140 and operation S150.

In operation S140, a plurality of first entries corresponding to same products having production dates falling within a same time range are merged into a second entry to obtain a plurality of second entries, wherein each of the second entries includes a production quantity of a same product in a time range.

After the first scheduling result of the product is obtained, the production sequences of various models of products may be adjusted, so that a plurality of first entries corresponding to same products having production dates falling within a same time range are merged into a second entry to obtain a plurality of second entries, wherein each of the second entries includes a production quantity of a same product in a time range. The above process may be understood as integrating the same products in different orders having production dates falling within the same time range, so as to obtain a sorting result with a product (or a product model) as a dimension. Based on the above method, same products having production dates falling within a same time range may be sorted together, thereby avoiding the situation of discontinuous production.

According to the embodiments of the present disclosure, the production date described above may be, for example, in units of days or weeks, and the time range may be, for example, in units of months or quarters. They may be set according to actual production scheduling conditions, and are not limited here.

In some embodiments, the integrated results may be sorted based on the product sorting dimension to obtain sorting results of various products (or product models). For example, the product sorting dimension may consider at least one of the following factors: the demand quantity of the product within a time range, the quantity of available production lines corresponding to the product, and the production cycle of the product. Based on the above sorting method, in the case of limited production capacity, the allocation of production capacity resources may be determined according to the adjusted product production sequence, so as to achieve the hierarchical utilization of production capacity and further improve the utilization rate of production capacity.

Table 3 schematically shows the adjusted scheduling results of the product described above. For example, within a time range in a unit of month, after the first scheduling results obtained in Table 2 are adjusted, all first entries with product model A1 having production dates falling in 2021/8 are integrated into a second entry, and the second entry indicates that the planned production quantity of the product of model A1 in 2021/8 is 44523. Similarly, all first entries with product model A4 planned to be produced in 2021/8 are integrated into another second entry. By analogy, a plurality of second entries as shown in Table 3 are obtained.

After the above first entries are integrated, the integrated results (i.e., a plurality of second items obtained) may also be sorted to obtain the corresponding production sorting condition of the product (see the column of product sorting in Table 3). As shown in Table 3, for a plurality of second entries involving the same time range (for example, August 2021), the second entries may be sorted according to the demand quantity of the product within the time range, so as to determine the sorting as: A1>A4>A2>A5>A6. In this way, a more realistic sorting result may be obtained.

The combination of different orders may be achieved based on the above adjustment method. In the case of limited production capacity, the allocation of production capacity resources may be determined according to the adjusted product production sequence, so as to achieve the hierarchical utilization of production capacity and further improve the utilization rate of production capacity. In addition, based on the above method, discontinuous production may also be avoided.

TABLE 3

| | | | | Planned | Available | | |
|---|---|---|---|---|---|---|---|
| | | | | production | production | Product | |
| | Product | Planned | Demand | line | line | production | Product |
| Plant | model | production time | quantity | quantity | quantity | cycle | sorting |
| Plant1 | A1 | 2021 August | 44523 | 1 | 1 | 1 | 1 |
| Plant 1 | A4 | 2021 August | 15874 | 2 | 2 | 1 | 2 |
| Plant 1 | A2 | 2021 August | 10623 | 1 | 2 | 1 | 3 |
| Plant 1 | A5 | 2021 August | 9540 | 1 | 2 | 1 | 4 |
| Plant 1 | A3 | 2021 August | 3721 | 2 | 3 | 1 | 5 |
| Plant 1 | A6 | 2021 August | 1752 | 1 | 1 | 1 | 6 |
| Plant 1 | A11 | 2021 September | 42351 | 2 | 2 | 2 | 1 |
| Plant 1 | A12 | 2021 September | 18254 | 1 | 1 | 2 | 2 |
| Plant 1 | A13 | 2021 September | 15201 | 1 | 1 | 2 | 3 |

In operation S150, for the product in each second entry, the orders corresponding to the product are acquired and the orders of the product are sorted according to at least one of an order delivery date and an order priority to obtain an order sorting result.

In the embodiments of the present disclosure, on the basis of the above sorting result, the second entry may be further sorted according to the order delivery date or the order priority, and the above sorting result is adjusted more finely, so as to obtain a more accurate product scheduling result.

The order sorting dimension may include, for example, the order delivery date or order priority of orders to be sorted. The earlier the delivery date of the order, the higher the priority. The priority of the order may be defined by referring to the delivery date and costs of the order. The priority sequences of the order may be set have five levels (exemplary only), for example, a red line>A>B>C>D, wherein the red line indicates a situation that the order sorting must be in the front (such as a production order in an emergency situation), after a comprehensive consideration of the order delivery date and the costs are taken into account, and the priority thereof is the highest.

After the products are sorted by product dimension, for each model of product, orders corresponding to each model of product are obtained, and for each model of product, orders of this model of product are sorted according to at least one of the order delivery date and the order priority, so as to obtain an order sorting result in this model of product. By using the above method, on the basis of the product sorting, the sorting result of the product sorting dimension may be further refined from the order sorting dimension, so that the product sorting result is more accurate.

Table 4 schematically shows the order sorting result of the product model A1 in Table 3. Please refer to Table 3 and Table 4 together. In Table 3, in the time range in a unit of month, all first entries with product model A1 planned to be produced in 2021/8 are integrated into the second entry as shown in Table 3, wherein there are three orders corresponding to product model A1 (exemplary only), such as orders A1-001 to A1-003.

It may be understood that if sorting is performed only from the product sorting dimension, a plurality of orders corresponding to each product may not be sorted accurately. There may be a situation that an order that should be sorted in the front may actually be sorted in the following. In order to obtain a more accurate product scheduling result, the orders A1-001 to A1-003 corresponding to the product model A1 may be sorted according to the method in operation S150 to obtain the order sorting result (as shown in Table 4).

TABLE 4

| | | | | | Product | Order |
|---|---|---|---|---|---|---|
| Product | Order | Demand | Order | Demand | sorting | sorting |
| model | number | quantity | delivery date | priority | result | result |
| A1 | A1-001 | 20000 | 2021 Aug. 1 | Red line | 1 | 1 |
| A1 | A1-002 | 20000 | 2021 Aug. 10 | P1 | 1 | 2 |
| A1 | A1-003 | 4523 | 2021 Aug. 30 | P2 | 1 | 3 |

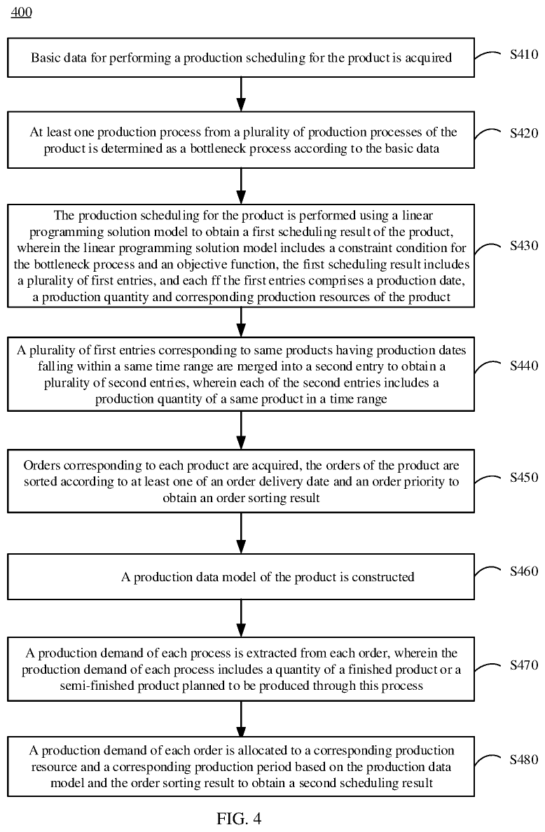

FIG. 4 is a flowchart of a method of production scheduling for a product according to another embodiment of the present disclosure.

As shown in FIG. 4, in the embodiments of the present disclosure, the method 400 of production scheduling for a product includes operations S410 S480. Operation S410 to operation S450 are respectively implemented in the same manner as operation S110 to operation S150, and the repeated parts will not be described in detail.

In operation S410, basic data for performing a production scheduling for the product is acquired.

In operation S420, at least one production process from a plurality of production processes of the product is determined as a bottleneck process according to the basic data.

In operation S430, the production scheduling for the product is performed using a linear programming solution model to obtain a first scheduling result of the product, wherein the linear programming solution model includes a constraint condition for the bottleneck process and an objective function, the first scheduling result includes a plurality of first entries, and each of the first entries comprises a production date, a production quantity and corresponding production resources of the product.

In operation S440, a plurality of first entries corresponding to same products having production dates falling within a same time range are merged into a second entry to obtain a plurality of second entries, wherein each of the second entries includes a production quantity of a same product in a time range.

In operation S450, for the product in each of the second entries, orders corresponding to the product are acquired and the orders of the product are sorted according to at least one of an order delivery date and an order priority to obtain an order sorting result. In some embodiments, the inventory quantity of the product may also be removed from each order in the obtained order sorting result, so that each order includes a net production demand.

In operation S460, a production data model of the product is constructed.

In the embodiments of the present disclosure, the production path, raw materials, semi-finished products/finished products, production capacity, and inventory information for each product model may be obtained based on the basic data obtained above. The production data model of the product for each product mode may be obtained based on the above data or information. For example, a SupplyNet engine may be used to construct a production data model. The SupplyNet engine is a background program for production scheduling, and it may be used for example but not limited to usage in basic data inspection production plan simulation, plan report analysis, plant capacity utilization analysis, etc.

The production data model here may include, for example, a correlation between a semi-finished product and production resources, materials and processes used to produce the semi-finished product, a correlation between a finished product and production resources, materials and processes used to produce the finished product, and a correlation between the finished product and the semi-finished product.

Taking the construction of the production data model of the display module as an example, according to the obtained basic data, the production data model of the display module for each product model is constructed according to the method of operation S460. The production data model includes a correlation between a semi-finished product (including an array substrate and a display cell including the array substrate) and production resources, materials and processes used to produce the above semi-finished products, a correlation between a finished product (including a display module of the display cell) and production resources, materials and processes used to produce the finished product, and a correlation between the finished product (including the display module of the display cell) and the semi-finished product (including an array substrate and a display cell including the array substrate).

In operation S470, a production demand of each process is extracted from each order, wherein the production demand of each process includes a quantity of a finished product or a semi-finished product planned to be produced through this process.

The production demand of the finished product is extracted from each order, and then the production demand of the finished product is converted into the production demand of each process according to the correlation between the finished product and the semi-finished product, the correlation between the materials and the processes, etc. The production demand of each process includes the quantity of the finished or semi-finished product planned to be produced through this process. The conversion of the production demand of the finished product into the production demand of each process is the same as or similar to the process of confirming the production demand of each process described above, and will not be repeated here.

In operation S480, a production demand of each order is allocated to a corresponding production resource and a corresponding production period based on the production data model and the order sorting result to obtain a second scheduling result.

With the production data model and order sorting result of the product obtained based on the above construction, the production resource situation of each process, the sorting situation of the order, the delivery date of the order may be obtained. Accordingly, the production demands of orders may be allocated to the corresponding production resource and corresponding production period according to the order sorting result, the delivery date of the order, etc., so as to obtain the second scheduling result.

In the embodiments of the present disclosure, for example, the production demands of orders may be allocated to the corresponding production resource and the corresponding production period based on the production data model and the order sorting result through a Forward Scheduling method to obtain the second scheduling result.

The forward scheduling method generally refers to that according to a preferred sequence in the order sorting result, a schedule is arranged starting from a previous order to a subsequent order until all orders are schedule. During this process, it is usually possible to arrange orders in a timely manner according to the capacity utilization of production resources to consume the remaining capacity, so as to improve the capacity utilization of production resources.

It should be noted that in the embodiments of the present disclosure, the allocation of the production demands of orders to the corresponding production resource and the corresponding production periods is not limited to the forward scheduling method. In other embodiments, other appropriate methods may be selected according to the actual situation. For example, a Backward Scheduling method may be used, which is not limited in the present disclosure.

In the embodiments of the present disclosure, a relatively more reasonable second scheduling result is provided based on the production data model and the order sorting result, which improves capacity utilization and production efficiency.

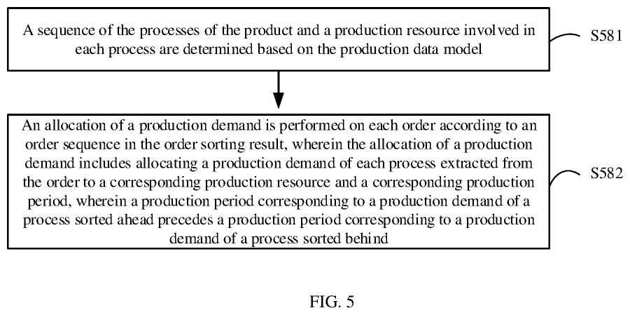

FIG. 5 is a flowchart of a method for obtaining a second scheduling result based on a production data model and an order sorting result according to an embodiment of the present disclosure. An exemplar implementation of the above operation S480 will be described below with reference to FIG. 5.

As shown in FIG. 5, the method for obtaining the second scheduling result based on the production data model and the order sorting result includes operations S581-S582.

In operation S581, a sequence of the processes of the product and a production resource involved in each process are determined based on the production data model.

As described above, the production data model may include a correlation between a semi-finished product and production resources, materials and processes used to produce the semi-finished product, a correlation between a finished product and production resources, materials and processes used to produce the finished product, and a correlation between the finished product and the semi-finished product. Therefore, the sequence of each process of the product and the production resources involved in each process may be determined according to the constructed production data model.

In operation S582, an allocation of a production demand is performed on each order according to an order sequence in the order sorting result, wherein the allocation of a production demand includes allocating a production demand of each process extracted from the order to a corresponding production resource and a corresponding production period, wherein a production period corresponding to a production demand of a process sorted ahead precedes a production period corresponding to a production demand of a process sorted behind.

In the process of allocating production demand for each order, if the production resources allocated to each process are sufficient, the production demand of each process extracted from each order may be flexibly allocated to the corresponding production resource and the corresponding production period according to the order sorting result and the order delivery date. Accordingly, a more reasonable scheduling result may be obtained, thereby improving the production efficiency and the capacity utilization rate.

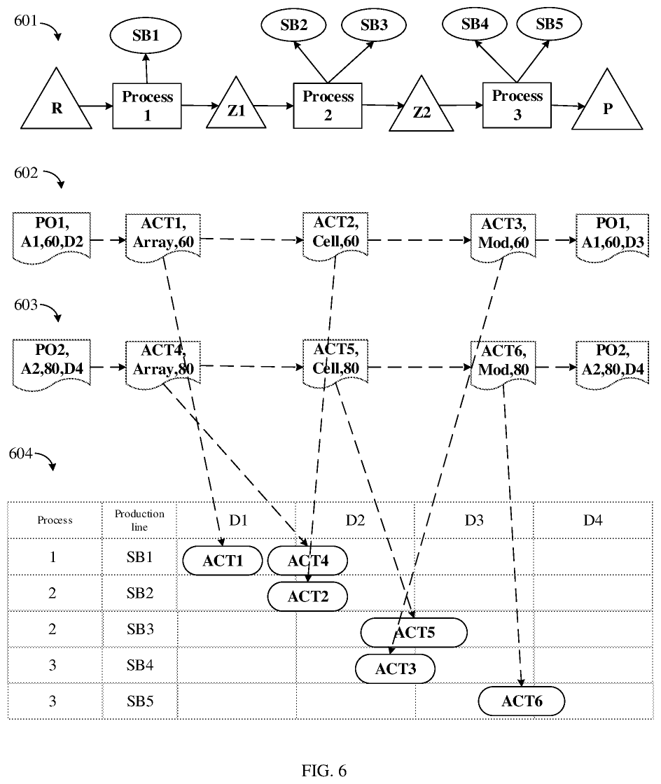

FIG. 6 is a schematic diagram of obtaining a second scheduling result based on a production data model and an order sorting result according to an embodiment of the present disclosure. The solution of the present disclosure will be described below with reference to FIG. 6 and taking the determination of the second scheduling result of the display module as an example. FIG. 6 schematically shows the production data model 601 of the display module obtained by construction, a plurality of orders (for example, 602 and 603) in the order sorting result, and the second scheduling result 604 obtained by allocating a plurality of orders (for example, 602 and 603) in the order sorting result based on the production data model 601 to each production resource used to produce the display module. It should be noted that what is shown in FIG. 6 is only an example, intended to help those skilled in the art understand the solution of the present disclosure, and is not intended to limit the protection scope of the present disclosure.

As shown in FIG. 6, according to the production data model 601, a correlation between a semi-finished product and production resources, materials and processes used to produce the semi-finished product, a correlation between a finished product and production resources, materials and processes used to produce the finished product, and a correlation between the finished product and the semi-finished product. For example, according to the production data model 601, it may be determined that a semi-finished product Z1 is obtained from a raw material R through a process 1, a semi-finished product Z2 is obtained from the semi-finished product Z2 through a process 2, and a finished product P is obtained from the semi-finished product Z2 through a process 3. According to the production data model 601, it may also be determined that a production resource available for the process 1 includes a production line SB1, a production resource available for the process 2 includes production lines SB2 and SB3, and a production resource available for the process 3 includes production lines SB4 and SB5. The above information determined according to the production data model 601 may be subsequently used for the second scheduling to maximize the utilization of production line capacity, thereby further improving the capacity utilization rate of the production line.

As shown by 602 and 603 in FIG. 6, two different orders P01 and P02 are involved in the first scheduling result. The sequence of the two orders may be determined by the above order sorting result, for example, the first order P01 precedes the second order P02. The production demand of each process may be extracted from each order. For example, the production information contained in the first order P01 includes, for example, a product model (e.g., product model A1), a planned production quantity (e.g., 60 pieces), and a planned delivery time of the product (e.g., D2). According to the planned production quantity of product model A1 in the first order P01, the production demand of each process may be determined. For example, the production demand of each process may be determined. For example, the production demand of the process 1, the process 2 and the process 3 of product model A1 may be determined as ACT1, ACT2 and ACT3 respectively, wherein the production demand ACT1 indicates that 60 semi-finished products Z1 need to be produced, the production demand ACT2 indicates that 60 semi-finished products Z2 need to be produced, and the production demand ACT3 indicates that 60 finished products P need to be produced. Based on the same manner, for the second order P02 (for example, product model A2, planned production quantity 80, planned delivery time D4), it may be determined that the production demands of the process 1, the process 2 and the process 3 of the product model A2 are ACT4, ACT5 and ACT6 respectively, wherein the production demand ACT4 indicates 80 semi-finished products Z1 need to be produced, the production demand ACT5 indicates 80 semi-finished products Z2 need to be produced, and the production demand ACT6 indicates 80 finished products P need to be produced.

Further referring to FIG. 6, based on the available production line situation obtained in the production data model 601 of the display module based on the above construction, for example, the production demands of various processes extracted from a plurality of orders of the display module (such as the first order P01 and the second order P02) are allocated to the corresponding production resources (such as production lines SB1, SB2, SB3, SB4, SB5) and the corresponding production periods (such as various periods in the dates D1 to D4) through the forward scheduling method, so as to obtain the second schedule result 604. D1 to D4 in the second scheduling result 604 represent consecutive dates, for example, respectively representing January 1, January 2, January 3 and January 4 in 2021. Of course, the embodiments of the present disclosure are not limited thereto, and the dates may be expressed in various other ways as needed, for example, D1 to D4 may also represent the first week, the second week, the third week and the fourth week of January 2021.

For example, as the first order P01 precedes the second order P02, a resource allocation is first performed on the production demand of each process extracted from the first order P01.

For the first order P01, according to the production data model 601, it is determined that the production resource available for the process 1 is the production line SB1, and therefore the production demand ACT1 (60 semi-finished products Z1 need to be produced) of the process 1 of the product model A1 in the first order P01 is allocated to the production line SB1 and the corresponding production period. In the present embodiment, as the time required to achieve the production demand ACT1 is less than a whole day, a portion of the period of the date D1 may be occupied, for example, 00:00 to 18:00 on Jan. 1, 2021. The production resource available for the process 2 includes production lines SB2 and SB3, and the production demand ACT2 (60 semi-finished products Z2 need to be produced) of the process 2 for the product model A1 in the first order P01 may be allocated to at least one of the production lines SB2 and SB3 and the corresponding production period. For example, in the example of FIG. 6, the production demand ACT2 is allocated to the production line SB2 and the corresponding production period. As the process 2 is arranged after the process 1 in the production sequence, the production period corresponding to the production demand ACT2 is after the production period corresponding to the production demand ACT1. In the present embodiment, as shown in FIG. 6, the production period to which the production demand ACT2 is allocated includes a latter portion of the period in the date D1 and a former portion of the period in the date D2. The production resource available for the process 3 includes production lines SB4 and SB5, and the production demand ACT3 (60 finished products P need to be produced) of the process 3 for the product model A1 in the first order P01 may be allocated to at least one of the production lines SB4 and SB5 and the corresponding production period. For example, in the example of FIG. 6, the production demand ACT3 is allocated to the production line SB4 and the corresponding production period. As the process 3 is arranged after the process 2 in the production sequence, the production period corresponding to the production demand ACT3 is after the production period corresponding to the production demand ACT2. In the present embodiment, as shown in FIG. 6, the production period to which the production demand ACT3 is allocated includes a latter portion of the period in the date D2 and a former portion of the period in the date D3.

As the take time of each process is different, the production capacity of the production resource available in each process may also be different, the production situation of each process may be adjusted according to the actual situation. For example, for the first order P01, if the production demand ACT3 of the process 3 for the product model A1 is completed on the production line SB4, as the actual delivery time of the finished product is D3, this will lead to a delivery delay of the order (its planned delivery time is D2). If the production demand ACT3 of the process 3 is completed in the production line SB5, as the production capacity of the production line SB5 is higher than that of the production line SB4, the finished product may be completed before the planned delivery time.

After the production demand of each process extracted from the first order P01 is allocated to each production line for producing the display module, the production demand of each process extracted from the second order P02 may allocated the remaining production resource according to the remaining capacity and the planned delivery time of the second order P02.

Referring to FIG. 6, for the second order P02, as the production resource available for the process 1 is the production line SB1, the production demand ACT4 of the process 1 for the product model A2 in the second order P02 is allocated to the production line SB1, and the production period of the production demand ACT4 is after the production period of the production demand ACT1 of the process 1 in the first order P01. The production resource available for the process 2 includes production lines SB2 and SB3. If the production line SB2 has a remaining capacity, the production demand ACT5 of the process 2 for the product model A2 in the second order P02 may be allocated to the production line SB2, or allocated to the production line SB3. A specific selection may be performed according to the actual situation, and is not limited. Similarly, the production demand ACT5 is allocated to the corresponding production period, after the production period corresponding to the production demand ACT4. In the present embodiment, the production period corresponding to the production demand ACT5 includes the latter portion of the period in the date D2 and the former portion of the period in the date D3. In a similar manner, the production demand ACT6 is allocated to the production line SB4 or SB5 and the corresponding production period (the latter portion of the period in the date D3 and the former portion of the period in the date D4), which will not be repeated here.

By allocating various production demands extracted from the first order P01 and the second order P02 according to the above method, the maximum utilization of production capacity may be achieved on the premise of meeting the order delivery deadline, thereby further improving the capacity utilization rate of production resources.

The second scheduling is described above by taking two orders as an example, but the embodiments of the present disclosure are not limited thereto, and the second scheduling may be performed on any quantities of orders in the above manner.

According to the embodiments of the present disclosure, the present disclosure also provides an electronic device, a readable storage medium, and a computer program product.

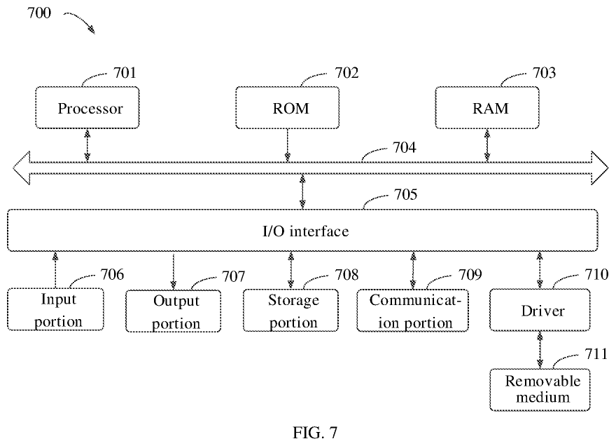

FIG. 7 is a block diagram of an electronic device for implementing an information recognition method for a product according to an embodiment of the present disclosure.

As shown in FIG. 7, an electronic device 700 according to an embodiment of the present disclosure includes a processor 701 that may perform various appropriate actions and processing according to a program stored in a read-only memory (ROM) 702 or a program loaded from a storage section 708 into a random access memory (RAM) 703. The processor 701 may include, for example, a general-purpose microprocessor (e.g., a CPU), an instruction set processor and/or a related chipset, and/or a special-purpose microprocessor (e.g., an application-specific integrated circuit (ASIC)), and the like. The processor 701 may also include an on-board memory for a caching purpose. The processor 701 may include a single processing unit or a plurality of processing units for executing different actions of the method flow according to the embodiments of the present disclosure.

In the RAM 703, various programs and data necessary for the operation of the electronic device 700 are stored. The processor 701, the ROM 702, and the RAM 703 are connected to one another via a bus 704. The processor 701 executes programs in the ROM 702 and/or the RAM 703 to perform various operations according to the method flow in the embodiments of the present disclosure. It should be noted that the programs may also be stored in one or more memories other than the ROM 702 and the RAM 703. The processor 701 may also executes programs stored in one or more memories to perform various operations according to the method flow in the embodiments of the present disclosure.

According to the embodiments of the present disclosure, the electronic device 700 may further include an input/output (I/O) interface 705, and the input/output (I/O) interface 705 is also connected to the bus 704. The electronic device 700 may also include one or more of the following components connected to the I/O interface 705: an input portion 706 including a keyboard, a mouse, etc.; an output portion 707 including a cathode ray tube (CRT), a liquid crystal display (LCD), a speaker and the like; a storage portion 708 including a hard disk and the like; and a communication portion 709 including a network interface card such as a LAN card, a modem, and the like. The communication portion 709 performs a communication processing via a network such as the Internet. A driver 710 is also connected to the I/O interface 705 as needed. A removable medium 711 such as a magnetic disk, an optical disk, a magneto-optical disk and a semiconductor memory is mounted on the driver 710 as needed, so that a computer program read therefrom is installed into the storage portion 708 as needed.

The present disclosure also provides a computer-readable storage medium. The computer-readable storage medium may be included in the device/apparatus/system described in the above embodiments, and it may also exist independently without being assembled into the device/apparatus/system. The above computer-readable storage medium carries one or more programs, and when the above one or more programs are executed, the method according to the embodiments of the present disclosure is implemented.

According to the embodiments of the present disclosure, the computer-readable storage medium may be a non-volatile computer-readable storage medium, for example may include but not limited to: a portable computer disk, a hard disk, a random access memory (RAM), a read-only memory (ROM), an erasable programmable read-only memory (EPROM or flash memory), a portable compact disk read-only memory (CD-ROM), ab optical storage device, a magnetic storage device, or any suitable combination of the above. In the present disclosure, a computer-readable storage medium may be any tangible medium that contains or stores a program. The program may be used by or in combination with an instruction execution system, an apparatus, or a device. For example, according to an embodiment of the present disclosure, a computer-readable storage medium may include one or more memories other than the ROM 702 and/or the RAM 703 and/or the ROM 702 and the RAM 703 described above.

According to the embodiments of the present disclosure, there is also provided a computer program product including a computer program. The computer program contains program codes for executing the methods shown in the flowcharts. When the computer program product runs in the computer system, the program codes are used to cause the computer system to implement the method of production scheduling for the product provided in the embodiments of the present disclosure.

When the computer program is executed by the processor 701, the above functions defined in the system/device of the embodiments of the present disclosure are executed. According to the embodiments of the present disclosure, the above-described system, device, module, unit, etc. may be implemented by computer program modules.

In one embodiment, the computer program may rely on a tangible storage medium such as an optical storage device and a magnetic storage device. In another embodiment, the computer program may also be transmitted and distributed in the form of a signal on a network medium, downloaded and installed through the communication portion 709, and/or installed from the removable medium 711. The program codes contained in the computer program may be transmitted by any appropriate network medium, including but not limited to: a wireless, wired medium, etc., or by any appropriate combination of the above.

In such an embodiment, the computer program may be downloaded and installed from a network via the communication portion 709 and/or installed from removable media 711. When the computer program is executed by the processor 701, the above functions defined in the system of the embodiments of the present disclosure are performed. According to the embodiments of the present disclosure, the above systems, device, apparatus, module, unit, etc. may be implemented by computer program modules.

According to the embodiments of the present disclosure, program codes for executing the computer programs provided by the embodiments of the present disclosure may be written in any combination of one or more programming languages. Specifically, an advanced procedure and/or an object-oriented programming language, and/or an assembly/a machine language may be used to implement these computing programs. Programming languages include, but are not limited to, Java, C++, python, “C” language or similar programming languages. The program codes may be executed entirely on a user computing device, partially on a user device, partially on a remote computing device, or entirely on a remote computing device or a server. In cases involving a remote computing device, a remote computing device may be connected to a user computing device over any kind of network, including a local area network (LAN) or a wide area network (WAN), or it may be connected to an external computing device (for example, connected over the Internet using an Internet service provider).

The flowcharts and block diagrams in the accompanying drawings illustrate the architecture, function, and operation implementable by the system, method and computer program product according to various embodiments of the present disclosure. In this regard, each block in a flowchart or a block diagram may represent a module, a program segment, or a portion of a code, and the above module, program segment, or portion of a code includes one or more executable instructions for executing specified logical functions. It should also be noted that, in some alternative implementations, functions marked in blocks may also occur in a sequence different from the sequence marked in the figure. For example, two blocks shown in succession may, in fact, be executed substantially concurrently, or they may sometimes be executed in a reverse sequence, depending upon the function involved. It should also be noted that each block in the block diagrams or flowcharts, and combinations of blocks in the block diagrams or flowcharts, may be implemented by a dedicated hardware-based system performing a specified function or operation, or may be implemented by a combination of dedicated hardware and computer instructions.

Those skilled in the art may understand that various combinations and/or collaborations of features recited in various embodiments and/or claims of the present disclosure may be made, even if such combinations or collaborations are not explicitly recited in the present disclosure. In particular, without departing from the spirit and teaching of the present disclosure, various combinations and/or collaborations of features recited in various embodiments and/or claims of the present disclosure may be made. All such combinations and/or collaborations fall within the scope of the present disclosure.

The embodiments of the present disclosure have been described above. However, these embodiments are for illustrative purposes only and are not intended to limit the scope of the present disclosure. Although various embodiments have been described separately above, this does not mean that the measurements in various embodiments may not be advantageously used in combination. The scope of the present disclosure is defined by the appended claims and the equivalents thereof. Various substitutions and modifications may be made by those skilled in the art without departing from the scope of the present disclosure, and these substitutions and modifications should all fall within the scope of the present disclosure.

1. A method of production scheduling for a product, comprising:
acquiring basic data for performing a production scheduling for a product;
determining at least one production process from a plurality of production processes of the product as a bottleneck process according to the basic data;
performing the production scheduling for the product using a linear programming solution model to obtain a first scheduling result of the product, wherein the linear programming solution model comprises a constraint condition for the bottleneck process and an objective function, the first scheduling result comprises a plurality of first entries, and each of the first entries comprises a production date, a production quantity and corresponding production resources of the product;
merging a plurality of first entries corresponding to same products having production dates falling within a same time range into a second entry to obtain a plurality of second entries, wherein each of the second entries comprises a production quantity of a same product in a time range; and
acquiring, for the product in each of the second entries, orders corresponding to the product and sorting the orders of the product according to at least one of an order delivery date and an order priority to obtain an order sorting result.

2. The method according to claim 1, further comprising:
constructing a production data model of the product, wherein the production data model comprises a correlation between a semi-finished product and production resources, materials and processes used to produce the semi-finished product, a correlation between a finished product and production resources, materials and processes used to produce the finished product, and a correlation between the finished product and the semi-finished product;
extracting a production demand of each of the processes from each of the orders, wherein the production demand of each of the processes comprises a quantity of a finished product or a semi-finished product planned to be produced through the process; and
allocating a production demand of each of the orders to a corresponding production resource and a corresponding production period based on the production data model and the order sorting result to obtain a second scheduling result, wherein the second scheduling result comprises a production demand corresponding to each production resource in each production period.

3. The method according to claim 2, wherein the allocating a production demand of each of the orders to a corresponding production resource and a corresponding production period based on the production data model and the order sorting result comprises:
determining a sequence of the processes of the product and a production resource involved in each of the processes based on the production data model; and
performing an allocation of a production demand on each of the orders according to an order sequence in the order sorting result, wherein the allocation of a production demand comprises allocating a production demand of each of the processes extracted from the order to a corresponding production resource and a corresponding production period, wherein a production period corresponding to a production demand of a process sorted ahead precedes a production period corresponding to a production demand of a process sorted behind.

4. The method according to claim 3, wherein the allocating a production demand of each of the processes extracted from the order to a corresponding production resource and a corresponding production period comprises:
allocating a production demand of each of the processes extracted from the order to a corresponding production resource and a corresponding production period by a forward scheduling method or a backward scheduling method.

5. The method according to claim 1, wherein the constraint condition comprises at least one of: a first constraint condition for a device capacity, a second constraint condition for a production line priority, a third constraint condition for a plant running time, a fourth constraint condition for a material, and a fifth constraint condition for a line changing frequency.

6. The method according to claim 5, wherein,
the first constraint condition indicates a sum of a planned production volume of each device for the day*takt time<device available time*device utilization rate;
the second constraint condition indicates that a priority of an internal plant is a first priority, a priority of an external foundry is a second priority, and the first priority is inferior than the second priority;
the third constraint condition indicates that a plant transit time is within a preset range;
the fourth constraint condition indicates that quantities of semi-finished products and materials used to produce a display module are within a preset range; and
the fifth constraint condition indicates that a quantity of models of the display module produced by each device per day is less than a preset value.

7. The method according to claim 1, wherein the objective function comprises at least one of: a first objective function configured to maximize a demand satisfaction degree for a product, a second objective function configured to minimize a quantity of a product with a delayed delivery date, a third objective function configured to maximize a utilization rate of a device for producing a product, a fourth objective function configured to minimize a plant running time, and a fifth objective function configured to maximize a time of a continuous production for a product on a same production line.

8. The method according to claim 7, wherein,
the first objective function is Max (demand satisfaction degree), wherein the demand satisfaction degree=an accumulated quantity of display modules to be delivered in multiple orders/a total demand quantity of display modules;
the second objective function is Min(delayed delivery quantity), wherein the delayed delivery quantity=an accumulated quantity of display modules to be delivered out of a delivery date in multiple orders/a total demand quantity of display modules;
the third objective function is Max(device capacity utilization rate), wherein the device capacity utilization rate=an accumulated device usage time in one day/an accumulated (a device availability time*a device utilization rate) in one day;
the fourth objective function is Min(inter-plant transit time), where the plant running time is an accumulated inter-plant transportation time in multiple orders;
the fifth objective function is Max(time of a continuous production for a display module of each model on a same production line);
wherein Max( ) represents to maximize a calculation, and Min( ) represents to minimize a calculation.

9. The method according to claim 1, further comprising: removing a stock quantity from each of the orders in the order sorting result, after obtaining the order sorting result.

10. The method according to claim 1, wherein the production date is in a unit of day or week, and the time range is in a unit of month or quarter.

11. The method according to claim 1, wherein the product is a display module, the semi-finished product comprises an array substrate and a display unit comprising an array substrate, and the finished product is a display model comprising a display unit.

12. The method according to claim 1, wherein the determining at least one production process from a plurality of production processes of the product as a bottleneck process comprises:
selecting at least one process from a plurality of processes involved in a post core process of the product as the bottleneck process of the product based on a production demand of a plant used to produce the product.

13. An electronic device, comprising a memory and a processor, wherein the memory stores instructions executable by the processor therein, and the instructions, when executed by the processor, cause the processor to perform the method according to claim 1.

14. A non-transitory computer-readable storage medium storing computer instructions, wherein the computer instructions are configured to cause the computer to perform the method according to claim 1.

15. A computer program product, comprising a computer program, wherein the computer program, when executed by a processor, implements the method according to claim 1.
